(19) United States
(12) Patent Application Publication
(10) Pub. No.: US 2003/0172305 A1
(43) Pub. Date: Sep. 11, 2003

(54) Vulnerabilities resistant server system and software thereof

(76) Inventor: Shinsuke Miwa, Tokyo (JP)

Correspondence Address: BIRCH STEWART KOLASCH & BIRCH, PO BOX 747, FALLS CHURCH, VA, 22040-0747, US

(21) Appl. No.: 10/234,187

(22) Filed: Sep. 5, 2002

(30) Foreign Application Priority Data
Mar. 5, 2002 (JP) 2002-059317

(51) Int. Cl. H04L 9/00

(52) U.S. Cl. 713/201

(57) ABSTRACT

The present invention aims to provide a server system and software thereof improved so that the server system can be reliably protected from the attacks targeting the vulnerabilities peculiar to the server system. A host operating system 11 is operated in association with hardware 10 and a virtual machine of a real machine is emulated by an emulator 12 so that this virtual machine operates as an active system 13. Attack targeting the active system 13 is detected by a behavior monitoring mechanism 15 and thereupon an active system substituting mechanism 16 activates another active system.

### FIELD OF THE INVENTION

The present invention relates to a vulnerabilities resistant server system and software thereof in network and particularly relates to an effective counter-measure against vulnerability-attack targeting such server.

### BACKGROUND OF THE INVENTION

Rapid popularization of internet in recent years has activated not only E-mail but also business activities in form of E-commerce and E-auction.

Consequently, high scale-resistance and availability have been required for various services and, at the same time, it has become an essential issue to improve the network security.

Particularly various attacks targeting the server system such as illegal access and cracking to the server system have increased in these years. These attacks have a tendency to be automated and dispersed, so the indiscriminate attacks have become everyday affairs.

Such attacks targeting the networks now serving as arteries for economics may give the economic activities a serious shock and are raising a social issue because these attacks may include not only so-called criminal for pleasure but also terrorist activities.

Most of the attacks are carried out in form of “illegal acquisition of the host as a stepping-stone by vulnerability attack” taking steps of illegally acquiring competence (particularly manager's competence) utilizing vulnerabilities of operating system or service software, high-jacking the host or disabling the service on the basis of the illegally acquired competence, and carrying out dispersed attacks using the high-jacked host as the stepping-stone.

In addition, various types of attack have appeared, for example, service disabling attack intending to force loss of dispersed resources and Worm proliferating through vulnerability attack for automatically ensuring the stepping-stone. In this manner, targets for attack have become indiscriminate, so it is apprehended that all the servers may be exposed to such attacks so far as the servers have vulnerabilities.

The conventional measures for network security against such attacks include FireWall, Security Proxy&Gateway and VPN.

However, all of these measures intend to clear-away illegal access on network and it is difficult to apply these conventional measures to the public server offering services to unspecified number of users.

Certainly, Service Wrapper technique is applicable also to the public server because this technique is adapted to limit and/or control access to the service and to clear-away an access when the host can determine this access to be illegal.

However, it is difficult even for this technique to clear-away the general attack assuming a normal communication. Furthermore, the Service Wrapper itself is nothing but the software operating in association with the host and therefore may be exposed to the attacks. With a consequence, this technique of well known art can not reliably protect the system from the various attacks.

In view of the problems accompanying the conventional techniques, it is a principal object of the present invention to provide a server system and software thereof improved so that the server system can be reliably protected from the attacks targeting the vulnerabilities peculiar to the server system.

### SUMMARY OF THE INVENTION

The object set forth above is achieved, according to the invention, by a vulnerabilities resistant server system as will be described below.

Specifically, this invention provides a vulnerabilities resistant server system used for internet or intranet and having its active system functioning as usual server implemented in the form of a virtual machine.

This server system comprises a control mechanism serving to control said active system, a behavior monitoring mechanism serving to monitor operating state of said active system, and an active system substituting mechanism adapted to substitute said active system with another active system implemented in a different virtual machine when said behavior monitoring mechanism detects and/or not detects the predetermined operating state of said first-mentioned active system so that these mechanisms may cooperate one another and thereby effectively overcome the vulnerability attack.

The vulnerabilities resistant server system according to the invention may be implemented so that the active system after substitution by said active system substituting mechanism can offer the same service as has been offered by the active system before substitution by said active system substituting mechanism.

The invention provides also the vulnerabilities resistant server used for internet or intranet and having its active system functioning as usual server implemented in the form of a virtual machine, said server system comprising a control mechanism serving to control said active system, a behavior monitoring mechanism serving to monitor an operating state of said active system, and a roll back mechanism adapted to roll back said active system to predetermined operating state when said behavior monitoring mechanism detects and/or not detects said predetermined operating state of said active system.

The invention provides also vulnerabilities resistant server system software used for internet or intranet and having its active system functioning as usual server implemented in the form of a virtual machine, said server software comprising a control section serving to control said active system, a behavior monitoring section serving to monitor operating state of said active system, and an active system substituting section adapted to substitute said active system with another active system implemented in a different virtual machine when said behavior monitoring section detects and/or not detects the predetermined operating state of said first-mentioned active system.

The software may be implemented also so that the active system after substitution by said active system substituting section can offer the same service as has been offered by the active system before substitution by said active system substituting section.

Alternatively, the vulnerabilities resistant server software used for internet or intranet and having its active system functioning as usual server implemented in the form of a virtual machine, said server system may comprise a control section serving to control said active system, a behavior monitoring section serving to monitor an operating state of said active system, and a roll back section adapted to roll back said active system to predetermined operating state when said behavior monitoring section detects and/or not detects said predetermined operating state of said active system.

### BRIEF DESCRIPTION OF THE DRAWINGS

FIG. 1 is a conceptual diagram (1) illustrating a vulnerabilities resistant server system according to the invention;

FIG. 2 is a conceptual diagram (2) illustrating a vulnerabilities resistant server system according to the invention; and

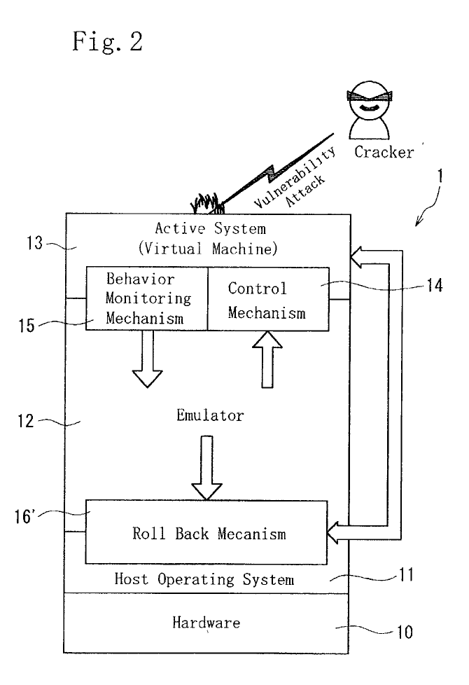

FIG. 3 is a diagram illustrating a construction according to the invention adapted to emulate a real machine.

### IDENTIFICATION OF REFERENCE NUMERALS USED IN THE DRAWINGS

| | |
|---|---|
| 1 | vulnerabilities resistant server system |
| 10 | hardware |
| 11 | host operating system |
| 12 | emulator |
| 13 | active system |
| 14 | control mechanism |
| 15 | behavior monitoring mechanism |
| 16 | active system substituting mechanism |

### DETAILED DESCRIPTION OF THE INVENTION

Details of the invention will be more fully understood from the description given hereunder in reference with the accompanying drawings showing preferred embodiments not intending to limit the invention but merely for illustration of the invention.

Term “vulnerabilities” used herein generally means all factors causing abnormal behaviors latently occurring in hardware, operating system, software of server system, for example, bug and setting error. Attacks targeting these vulnerabilities illegally use appropriate communication network and/or control instruction to elicit such latent abnormal behaviors which are used for wrong purposes of intentionally causing failures or illegally acquiring some competences.

In view of the fact that the attacks targeting the vulnerabilities use the latent normal behaviors using normal communication, it is extremely difficult for the server side to take any defensive measures until the particular vulnerabilities are recognized by the server.

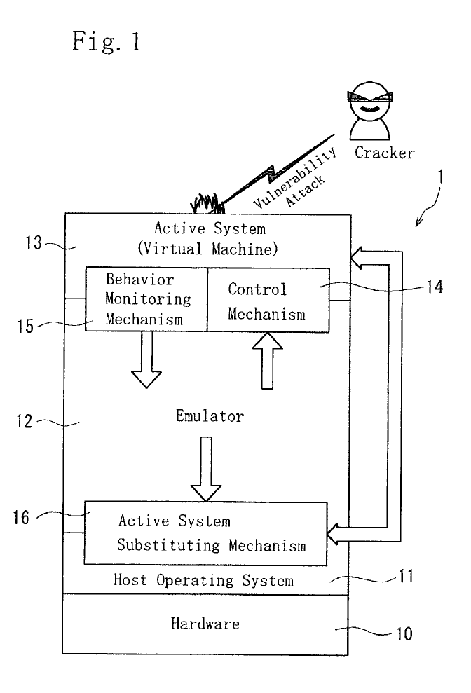

The present invention aims to provide a server system which is well resistant to such vulnerabilities, as schematically illustrated by a conceptual diagram in FIG. 1. In a server system (1) according to the invention, an emulator (12) operates in association with hardware (10) and a host operating system (11) so as to emulate an active system (13) as a virtual machine (VM).

The emulator (12) realizes a function of a real machine having a predetermined architecture in the form of software and thereby constructs virtual computer environment. An example of such emulator (12) is VMware (Trademark).

[Reference] Networld Inc. “VMware virtual platform technical whitepaper”

http://www.networld.co.jp/products/vmware/index.htm

Emulation of the real machine by the emulator (12) makes the active system (13) equivalent to the real machine of the server system (1). Therefore, the existing service software is available and the device as well as the network necessary for the service is also available.

The active system (13) emulated by the emulator (12) in the form of the virtual machine is not required to know the presence of the real machine, that is, in the server system (1) the made up according to the invention, the presence of the real machine can not be known.

The real machine is covered up behind the active system (13) which is actually attacked, so it is impossible to attack the emulator (12) itself and substitution of the active system (13) can be performed without any adverse affection.

According to the invention, the emulator (12) includes a control mechanism (14) for the active system (13) and a behavior monitoring mechanism (15). The host operating system (11) includes an active system substituting mechanism (16) adapted to operate in association with the control mechanism (14) and the behavior monitoring mechanism (15) to achieve substitution of the active system (13).

Operation of the respective mechanisms (13), (14) and (15) will be described in details.

In the present embodiment, the control mechanism (14) controls start-up, completion etc. so that the active system (13) can normally function as the active system (13) in the server system (1).

The behavior monitoring mechanism (15) monitors whether the emulated active system (13) normally operates or not and, if any abnormal event occurs, informs the control mechanism (14) or the active system (16) of this event.

When the behavior monitoring mechanism (15) detects, for example, memory leak or state abnormality in the emulated active system (13) (events such as band deficiency of the network and reboot), the control mechanism (14) causes the active system (13) to restore the normal operation so far as the behavior monitoring mechanism (15) determined that such restoration can be easily achieved.

In this case, there is no anxiety that the determination of the behavior monitoring mechanism (15) might be affected by any illegal operation by the third party because the behavior monitoring mechanism (15) is covered up behind the active system (13) as has previously been described.

When the behavior monitoring mechanism (15) determines that the desired restoration can not be easily achieved or such restoration should be abstained (the situation is dirty from the viewpoint of security), the behavior monitoring mechanism (15) calls for the active system substituting mechanism (16).

The active system substituting mechanism (16) causes the emulator (12) to start up another active system as the virtual machine so that this active system may continue to offer the same service as the service which has been offered by the not restored active system.

The active system substituting mechanism (16) also is covered up behind the active system (13) which has been determined to be in abnormal state, so it is impossible for the third party to operate the active system substituting mechanism (16) and the desired active system substitution can be effectively achieved even if the abnormal state has been intentionally caused

This roll back mechanism (16′) is adapted for, instead of substituting the active system (13) as in the previous embodiment, forcibly rolling back the active system (13) to a certain time point, for example, to snap-shot of the time point at which the behavior monitoring mechanism (15) had not detect any abnormality and thereby enables this active system (13) to continue its service.

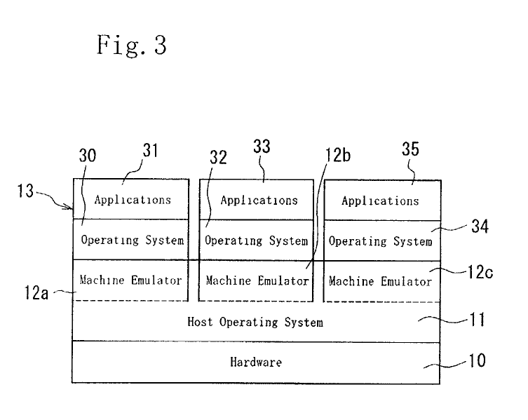

FIG. 3 is a diagram illustrating an arrangement in this embodiment adapted to emulate the real machine in the manner as has been described above. The arrangement comprises machine emulator (12a) adapted to emulate the active system (13), an operating system (30) cooperating with the active system (13), applications (31) such as software and duplex system (13′), (13′) always waiting until the active system substituting mechanism (16) requires it in the place of the active system (13).

In the duplex systems (13′), (13″) also, operating systems (32), (34) and applications (33), (35) operate in association with the virtual machines realized by the emulators (12b), (12c), respectively, so that the duplex system (13′) can be activated immediately when the situation requires substitution of the active system. The duplex systems (13′), (13″) may be set so that these duplex systems can offer the same service as the active system (13) upon the substitution.

Regarding the state of the duplex systems (13′), (13″), it is also possible to store the state of operation expected for these duplex systems, for example, on a hard disc (not shown) of the hardware (10) and to suspend it. More preferably, the state of operation expected for these duplex systems may be stored on a memory (not shown) to achieve more rapid substitution.

The same effect can be achieved merely by turning off only the interface without the suspension.

As has previously been described, the duplex systems (13′), (13″) may be covered up not only behind the active system (13) but also behind each other as well as behind the real machine.

In this way, if one of the systems (13), (13′), (13″) is vulnerability-attacked, the remaining systems as well as the real machine can be protected from such attack and the vulnerabilities resistant server system can be provided.

While the arrangement such that the real machine is emulated has been described above as a specific embodiment of the invention, it should be understood that a purely virtual computer environment can be made up from the architecture instead of emulating the real machine to obtain the virtual machine.

Such arrangement advantageously improves flexibility of the server system as a whole, on one hand, and improves a degree of isolation among the respective active systems, on the other hand, because of its independency from the real machine's architecture. With consequence, the behavior monitoring mechanism, the active system substituting mechanism and the roll back mechanism can reliably operates against the vulnerability attack.

Also when the active system for exclusive use is provided instead of emulating the real machine, the server system according to the invention is able to offer the service software having the function equivalent to that of the real machine and to adopt the architecture in which the existing devices and networks can be transparently utilized.

The present invention can be implemented not only in the form of the server system (1) as has been described above but also in the form of the vulnerabilities resistant server software which may be introduced into the existing server system or personal computer to realize the server system similar to the system (1).

Construction of such software corresponding to the server system (1) minus the hardware (10) and it is possible for this construction to add the existing server system with the vulnerabilities resistant function. Such feature contributes to cost saving and particularly the embodiment adopting emulation of the real machine can avoid apprehension that the users might experience feeling of incompatibility because the system need not be significantly modified.

### EFFECT OF THE INVENTION

The present invention constructed as has been described is effective in aspects as will be described below.

Against unpredictable vulnerability attack, the active system in the form of the virtual machine can be controlled and substituted from the real machine, so the state abnormality can be always monitored and, upon detection of such state abnormality, appropriate countermeasure, for example, substitution of the active system can be taken.

The substitute active system can continue to offer the same service as the substituted active system. In this way, the server system according to the invention is well resistant to the service disabling attack against which conventionally no effective countermeasure has been found and thus contributes to improvement of the network security.

By substituting the attacked active system with another active system which differs from the attacked active system in its vulnerabilities, this substitute active system is resistant to the same vulnerability attack. In this way, the attack targeting the server system after the substitution can be annihilated and, at the same time, the vulnerabilities can be easily eliminated by correction of the operating system software and modification of design.

What is claimed is:

1. Vulnerabilities resistant server system used for internet or intranet and having its active system functioning as usual server implemented in the form of a virtual machine, said server system comprising:
a control mechanism serving to control said active system,
a behavior monitoring mechanism serving to monitor operating state of said active system, and
an active system substituting mechanism adapted to substitute said active system with another active system implemented in a different virtual machine when said behavior monitoring mechanism detects and/or not detects the predetermined operating state of said first-mentioned active system.

2. The vulnerabilities resistant server system according to claim 1, wherein the active system after substitution by said active system substituting mechanism is able to offer the same service as has been offered by the active system before substitution by said active system substituting mechanism.

3. The vulnerabilities resistant server software used for internet or intranet and having its active system functioning as usual server implemented in the form of a virtual machine, said server system comprising:
a control mechanism serving to control said active system,
a behavior monitoring mechanism serving to monitor an operating state of said active system, and
a roll back mechanism adapted to roll back said active system to predetermined operating state when said behavior monitoring mechanism detects and/or not detects said predetermined operating state of said active system.

4. Vulnerabilities resistant server system software used for internet or intranet and having its active system functioning as usual server implemented in the form of a virtual machine, said server software comprising:
a control section serving to control said active system,
a behavior monitoring section serving to monitor operating state of said active system, and
an active system substituting section adapted to substitute said active system with another active system implemented in a different virtual machine when said behavior monitoring section detects and/or not detects the predetermined operating state of said first-mentioned active system.

5. The vulnerabilities resistant server software according to claim 4, wherein the active system after substitution by said active system substituting section is able to offer the same service as has been offered by the active system before substitution by said active system substituting section.

6. Vulnerabilities resistant server software used for internet or intranet and having its active system functioning as usual server implemented in the form of a virtual machine, said server system comprising:
a control section serving to control said active system,
a behavior monitoring section serving to monitor an operating state of said active system, and
a roll back section adapted to roll back said active system to predetermined operating state when said behavior monitoring section detects and/or not detects said predetermined operating state of said active system.
